(19) United States
(12) Patent Application Publication
(10) Pub. No.: US 2024/0400857 A1
(43) Pub. Date: Dec. 5, 2024

(54) FILAMENT, ADDITIVE MANUFACTURING METHODS USING THE FILAMENT AND ARTICLES MANUFACTURED THEREBY

(71) Applicant: SOLVAY SPECIALTY POLYMERS USA, LLC, Alpharetta, GA (US)

(72) Inventors: Joel Flores, Anaheim, CA (US); Stéphane Jeol, Saint-Fons (FR); Christopher Ward, Sandy Springs, GA (US)

(73) Assignee: SOLVAY SPECIALTY POLYMERS USA, LLC, Alpharetta, GA (US)

(21) Appl. No.: 18/699,571

(22) PCT Filed: Oct. 3, 2022
(86) PCT No.: PCT/EP2022/077474

§ 371 Date: Apr. 8, 2024

(30) Foreign Application Priority Data
Oct. 6, 2021 (EP) 21306402.5

(51) Int. Cl. C09D 177/06; B29C 64/118; B29K 77/00; B29K 105/16; B33Y 10/00; B33Y 70/10; C08G 69/26; C08K 7/06; C09D 7/40; C09D 7/61

(52) U.S. Cl. CPC C09D 177/06; B33Y 70/10; C08G 69/265; C08K 7/06; C09D 7/61; C09D 7/70; B29C 64/118; B29K 2077/00; B29K 2105/16; B33Y 10/00

(57) ABSTRACT

An additive manufacturing filament is provided, as are 3D manufacturing methods using the filament, and articles and composite materials made therefrom. The filament comprises a polymer composition, and the polymer composition comprises, in turn, at least 50 wt. % of a polyamide. The polyamide comprises recurring units R_{(PA1)} from 30 mol % to 75 mol % recurring units R_{(PA1)} according to formula (V′); and •from 25 mol % to 70 mol % of at least one of recurring units R_{(PA2)}, R_{(PA3)} a and R_{(PA4)}, according to formulae (VI), (VII) and (VIII), respectively: •wherein ∘R₁ and R₂ are independently selected C₁ to C₃ alkyls; ∘Rᵢ, at each location, is selected from the group consisting of an alkyl, an aryl, an alkali or alkaline earth metal sulfonate, an alkyl sulfonate, and a quaternary ammonium; ∘i is an integer from 0 to 10; ∘R₃ is a C₇-C₁₆ alkyl, preferably a C₇-C₁₂ alkyl; ∘R₄ is a C₆ to C₂₀ alkyl or a C₆ to C₂₀ aryl, preferably a C₆ to C₁₆ alkyl or a C₆ to C₁₆ aryl, more preferably a C₆ to C₁₂ alkyl or a C₆ to C₁₂ aryl; and ∘mol % is relative to the total moles of recurring units in the polyamide. The filament has a cylindrical geometry and a diameter between 0.5 mm and 5 mm.

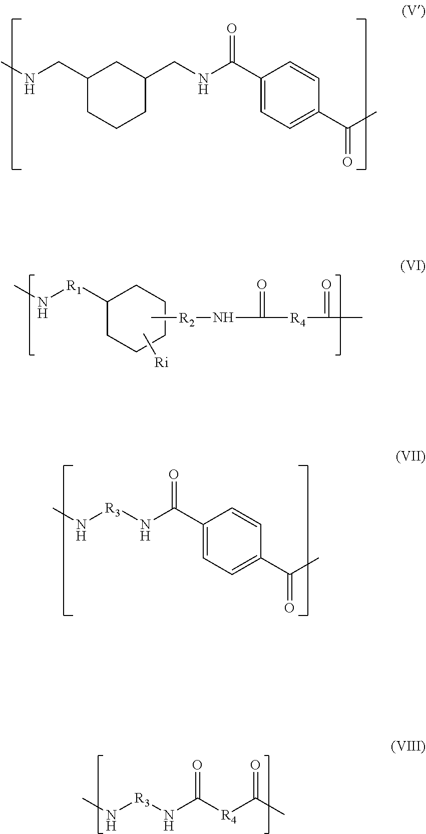

The present application claims the priority of European patent application EP 21306402.5 filed on 6 Oct. 2021, the content of which being entirely incorporated herein by reference for all purposes. In case of any incoherency between the present application and the PCT application that would affect the clarity of a term or expression, it should be made reference to the present application only.

### FIELD

Additive manufacturing, or 3D printing, is the process of manufacturing an article by the successive deposition of layers of material according to a digital pattern. In one form, a polymeric material is extruded through an extrusion tip and deposited in an x-y plane in accordance with the pattern, as a print head carrying the extrusion tip is incremented along the z-axis. The successively deposited layers fuse together and solidify upon a change in conditions until a 3D article in accordance with the digital pattern is provided.

Applicability of additive manufacturing processes is limited by the availability of suitable polymeric materials. Suitable polymeric materials not only must be amenable to this type of processing but also must provide the article manufactured with acceptable properties given its intended use.

Polyamides are one example of polymeric materials particularly useful in additive manufacturing processes. Aliphatic polyamides, in particular, typically have a broad thermal processing window, thus offering flexibility in processing. However, some aliphatic polyamides such as PA6, PA11 and PA12 have glass transition temperatures so low (e.g., less than 50° C.) as to render articles incorporating them less suitable for use in applications requiring higher modulus at elevated temperature.

Semi-aromatic polyamides, on the other hand, may provide advantageous mechanical properties at elevated temperature, but their higher processing temperatures can render them challenging to incorporate into additive manufacturing processes. For example, filament preparation with the requisite level of diameter specificity may not be possible with semi-aromatic polyamides.

### BACKGROUND ART

U.S. Pat. No. 10,633,490 (D1), U.S. Pat. No. 3,875,120 (D2) and EP 2767555A1 (D3) do not relate to the field of additive manufacturing and do not disclose a filament nor a spool as claimed.

### TECHNICAL PROBLEM

The invention relates more particularly to the fused filament fabrication (FFF) technology. There is a need for a polymeric composition having the adequate properties to be used in this technology.

The polymer composition needs to exhibit a combination of properties to be transformed easily into a filament and into a spool. Such a transformation needs also to be performed reproductively and with a good control of the diameter of the filament. The filament needs to be processable easily in the 3D printer and provide a 3D object with adequate quality and mechanical properties. The polymer composition needs to exhibit a high glass transition temperature (Tg) to impart interesting mechanical properties while exhibiting a suitable melting temperature (Tm) to keep the polymer composition processable in the FFF technology. The polymer composition should also exhibit a low water absorption to avoid degradation of the mechanical properties.

The invention aims at solving this technical problem.

### BRIEF DESCRIPTION OF THE INVENTION

The invention is set out in the appended set of claims.

The invention relates to a filamed as defined in any one of claims 1-39.

The invention also relates to a spool as defined in claim 40.

The invention also relates to a method as defined in claims 41-43.

The invention also relates to a use as defined in claim 44.

Further details and precisions are given below about these subject-matters.

### DETAILED DESCRIPTION

Any description, even though described in relation to a specific embodiment, is applicable to and interchangeable with descriptions of other embodiments. Where an element or component is said to be included in and/or selected from a list of recited elements or components, it should be understood that the element or component can be any one of the individual recited elements or components, or can also be selected from a group consisting of any two or more of the explicitly listed elements or components. Further, any such listed element or component may be omitted.

Any recitation of numerical ranges includes all numbers and subranges subsumed within the recited ranges as well as the endpoints of the range.

The amount of energy in the form of heat required to bring about a change of state of a thermoplastic polymer from the solid to the liquid form is the heat of fusion (“Hm”) of the polymer, and the temperature at which this change of state occurs is called the melting temperature (“Tm”). Amorphous materials lack a measurable Tm and have a Hm less than 5.0 J/g.

The terms “halogen” or “halo” include fluorine, chlorine, bromine and iodine.

As used herein, the terms “alkyl”, “alkylene”, “alkoxy”, “acyl” and “alkylthio”, include within their scope straight chain, branched chain and cyclic moieties. Examples of alkyl groups are methyl, ethyl, 1-methylethyl, propyl, 1,1-dimethylethyl and cyclopropyl.

Similarly, unless specifically stated otherwise, the term “aryl” is inclusive of both mono- and polynuclear aryl groups. The term “aryl” thus refers to a phenyl, indanyl or naphthyl group.

Furthermore, an aryl group may comprise one or more heteroatoms, e.g., N, O, or S, and in such instances may appropriately be referred to as a “heteroaryl” group. Such heteroaromatic rings may also be fused to other aromatic systems. Examples of heteroaromatic rings include, but are not limited to, furanyl, thienyl, pyrrolyl, pyrazolyl, imidazolyl, triazolyl, isoxazolyl, oxazolyl, thiazolyl, isothiazolyl, pyridyl, pyridazyl, pyrimidyl, pyrazinyl and triazinyl ring structures.

### The Filament of the Invention

As used herein, the term “filament” refers to a strand or thread made of or comprising the polymer composition (PC). The filament is suitably used in an additive manufacturing process.

The filament has a cylindrical geometry and diameter d between 0.5 mm and 5.0 mm.

d may be at least about 1.0 mm, 1.1 mm, 1.2 mm, 1.3 mm, 1.4 mm or 1.5 mm.

d may be no more than 5.0 mm, 4.5 mm, 4.0 mm, 3.5 mm, 3.25 mm, or 3.0 mm.

d may be from 1.0 mm to 5.0 mm, 1.1 mm to 4.5 mm, 1.2 mm to 4.0 mm, 1.3 mm to 3.5 mm, or from 1.4 mm to 3.25 mm or from 1.5 mm to 3.0 mm.

The filament is advantageously a solid cylinder, as opposed to being hollow.

The filament has also advantageously a substantially circular cross-section or a circular cross-section.

The length L of the filament is generally at least 200 mm.

The filament may be in the form of a spool. The invention thus also relates to a spool made of or comprising the polymer composition.

### Preparation of the Filament

The filament can be prepared in a two-step process wherein the polymer composition (PC) as disclosed herein is formed into pellets, and then the pellets are extruded to produce the filament. Alternatively, the filament may be prepared directly from the polymer composition (PC) in an integrated, one-step process.

The filament can be made from the polymer composition (PC) by methods including, but not limited to, melt-mixing processes. Melt-mixing processes are typically carried out by heating the polymer components above the highest melting temperature and glass transition temperature of the thermoplastic polymers thereby forming a melt of the thermoplastic polymers. In some embodiments, the processing temperature ranges from about 240-400° C., preferably from about 250-380° C., from about 260-360° C.

According to a preferred embodiment, the polymer composition (PC) is melt-mixed in an extruder, and the filament extruded therefrom. Preferably, use is made of an extruder fitted with means for dosing all the desired components of the polymer composition to the extruder, whether to the extruders throat or to the melt.

The components may be fed simultaneously as a powder or granule mixture, also known as dry-blend, or may be fed separately. The order of combining the components during melt-mixing is not critical. In some embodiments, the components can be mixed in a single batch, such that the desired amounts of each component are added together and subsequently mixed. However, the total desired amount of each component does not have to be mixed as a single quantity. In other embodiments, a partial quantity of one or more components can be initially added and mixed and, subsequently, some or all of the remainder can be added and mixed.

The filament may be formed by melt extrusion. Dies may be used to shape the articles, for example a die having a circular orifice if the article is a filament of cylindrical geometry. The extruded filament is cooled by immersing it in a bath, spraying it with liquid or passing it through a stream of inert gas. The solidified filament is then wound onto spools.

The method may comprise if needed several successive steps of melt-mixing or extrusion under different conditions. The method may also comprise one or more cooling steps.

The preparation of the filament may follow the procedure given in the experimental section.

### Additive Manufacturing

The filament of the invention can be used in an additive manufacturing method to provide a variety of three-dimensional articles or composite materials.

The filament can be provided to a Fused Filament Fabrication (FFF) method, also known as Fused Deposition Modelling (FDM). With this method, a 3D object is constructed layer by layer, each layer being made by heating the polymer composition (PC) of the filament.

The method comprises feeding the filament to a discharge member of a three-dimensional printer (or 3D printer), the discharge member having a throughbore ending with a discharge tip and a circumferential heater. The filament is heated within the discharge member while applying pressure to cause the discharge of the heated filament through the discharge tip onto a receiving platform or support structure. While the heated filament is being discharged, the discharge tip is moved in X-, Y- and/or Z-direction(s) to form the 3D object.

The filament is provided to the 3D printer, within which the filament is fed to a discharge head having a throughbore ending with a discharge tip. The throughbore is provided with a circumferential heater that heats the filament to a temperature of at least the Tm of the material, +10° C., in the throughbore. Additionally, the 3D printer may comprise a temperature controlled chamber in order to maintain the filament at a desired temperature, ideally within ±50° C. of the Tg of the material. The filament is compressed in the throughbore, with upstream material and/or a piston, in order to discharge the filament from the discharge tip onto a receiving platform.

While the filament is being discharged therefrom, the discharge tip is moved in the X, Y and/or Z directions relative to the receiving platform to form a desired 3D article or composite material.

In some embodiments, the filament may be discharged onto a support, for example a planar and/or horizontal support. The support may be moveable in all directions, for example in the horizontal or vertical direction. During the 3D printing process, the support can, for example, be lowered, in order for the successive layer of filament to be deposited on top of the former layer of filament. The support minimizes distortion of the article or composite material being formed by the discharged filament, particularly when the temperature of the support is maintained below the solidification temperature of the polymer composition of the filament.

In some embodiments, the support may be produced using the additive manufacturing method, using a support material. In some embodiments, the support material possesses a water absorption behaviour or a solubility in water at a temperature lower than 110° C. Any material suitable for use as a support for polymer filaments having a Tm<290° C. can be used as a support material for the present filament. Suitable support materials include, but are not limited to, polyvinyl alcohol and polyglycolic acid.

In embodiments of the additive manufacturing method wherein a support is used that is also produced by the additive manufacturing method, the method further comprises, prior to providing the filament provided herein to the printer, providing a filament comprising a support material to the 3D printer and printing the support structure from the support material. Once the desired article or composite material has been printed using the polyamide filament, at least a portion of the support structure is removed from the article or composite material.

In some embodiments, the article or composite material may be subjected to heat-treatment after formation. Suitable parameters for the heat treatment include exposure to a temperature of from 80° C. to 180° C., or from 100° C. to 160° C. for a time period of from about 30 minutes to 24 hours, or from 1 hour to 8 hours, under atmospheric pressure or vacuum, in presence or absence of nitrogen gas.

The invention thus also relates to the use of the polyamide (PA) or of the polymer composition (PC) in 3D printing.

The invention also relates to a method of making a three-dimensional (3D) object comprising the step of printing layers of the three-dimensional object with the polymer composition (PC) of the filament.

### Polyamide (PA)

The filament of the invention is made of or comprises a polymer composition (PC) which comprises at least 50.0 wt % of the polyamide (PA), about which more details are now given.

According to an embodiment, the polyamide (PA) is formed from the polycondensation of a diamine component (A) and a diacid component (B) wherein:
the diamine component (A) comprises:
   a) between 40.0 and 80.0 mol % of at least one bis(aminoalkyl)cyclohexane represented by formula (I):

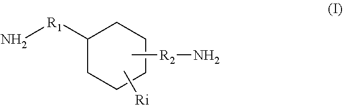

where the alkyl amino groups are relatively positioned in the meta position (1,3-) or the para position (1,4-); R₁ and R₂ are independently selected in the group consisting of C₁-C₃ alkylene groups; Rᵢ, at each location, is selected from the group consisting of an alkyl, an aryl, an alkali or alkaline earth metal sulfonate, an alkyl sulfonate, and a quaternary ammonium; and i is an integer from 0 to 4; and
b) between 20.0 and 60.0 mol % of at least one diamine of formula (II):

H₂N—R₃—NH₂ (II)
where R₃ is a C₇-C₁₆ aliphatic alkylene group;
these proportions in mol % being based on the total amount of diamines in the diamine component (A);
the diacid component (B) comprises:
   a) between 70.0 and 100.0 mol. % of terephthalic acid;
   b) between 0 and 30.0 mol. % of at least one dicarboxylic acid other than terephthalic acid of formula (III):

HOOC—R₄—COOH (III)
where R₄ is a C₄-C₂₀ alkylene group or a C₇-C₂₀ arylene group;
these proportions in mol % being based on the total amount of diacids in the diacid component (B).

The polyamide (PA) is formed from the polycondensation of the diamine component (A) and the dicarboxylic acid component (B). Therefore, the proportion of —NH₂ from the diamine component (A) and the proportion of —COOH from the dicarboxylic acid component (B) are substantially equimolar. The ratio amine/acid can be comprised between 0.9 to 1.1, preferentially 0.95 to 1.05, even more preferentially between 0.98 to 1.02.

The polyamide (PA) preferably does not comprise recurring units derived from a lactam or an amino-acid.

### About the Diamine Component (A)

The diamine component (A) comprises a bis(aminoalkyl)cyclohexane of formula (I) and one or more aliphatic diamine(s) of formula (II).

The bis(aminoalkyl)cyclohexane is represented by following formula (I):

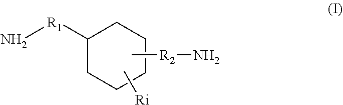

where R₁ and R₂ are independently selected in the group consisting of C₁-C₃ alkylene groups; Rᵢ, at each location, is selected from the group consisting of an alkyl, an aryl, an alkali or alkaline earth metal sulfonate, an alkyl sulfonate, and a quaternary ammonium; and i is an integer from 0 to 4. The alkyl amino groups are relatively positioned in the meta position (1,3) or the para position (1,4-).

In a preferred embodiment, i is 0 and R₁ and R₂ are both —CH₂—, so that the bis(aminoalkyl)cyclohexane is selected from 1,3-bis(aminomethyl)cyclohexane (“1,3-BAC”) and 1,4-bis(aminomethyl)cyclohexane (“1,4-BAC”).

Preferably, the bis(aminoalkyl)cyclohexane is 1,3-bis(aminomethyl)cyclohexane.

The bis(aminoalkyl)cyclohexane can be in a cis or trans conformation. Accordingly, the diamine component can include only the cis-bis(aminoalkyl)cyclohexane, only the trans-bis(aminoalkyl)cyclohexane.

The bis(aminoalkyl)cyclohexane can be a mixture of cis- and trans-bis(aminoalkyl)cyclohexane. The cis/trans ratio may be between 10/90 and 90/10, preferentially between 20/80 and 80/20 and even more preferentially between 30/70 and 70/30. In some embodiments, the cis/trans ratio is between 50/50 and 68/32.

Details are given about the proportions of the diamines in the diamine component (A). As it pertains to the diamine component, mol % of the referenced diamine is relative to the total number of moles of diamines in the diamine component (A).

The proportion of the bis(aminoalkyl)cyclohexane in the diamine component (A) is at least 40.0 mol % or at least 45.0 mol %. The proportion of bis(aminoalkyl)cyclohexane in the diamine component (A) is no more than 80.0 mol % or no more than 75.0 mol %. This proportion may be from 45.0 mol % to 75.0 mol %. This proportion may also be between 40.0 and 65.0 mol % or between 45.0 and 65.0 mol %.

The diamine component (A) also comprises one or more aliphatic diamine(s) of formula (II):

H₂N—R₃—NH₂ (II)

where R₃ is a C₇-C₁₆ aliphatic alkylene group, preferably a C₇-C₁₂ aliphatic alkylene group, preferably a C₇-C₁₂ aliphatic linear alkylene group.

Most preferably, the one or more aliphatic diamine(s) is/are selected from the group consisting of 1,9-diaminononane and 1,10-diaminodecane.

The proportion of the one or more aliphatic diamine(s) of formula (II) is at least 20 mol % or at least 25 mol % in the diamine component (A). This proportion may be no more than 60 mol % or no more than 55 mol %.

This proportion may be from 25.0 mol % to 55.0 mol %. This proportion may also be between 35.0 and 60.0 mol % or between 35.0 and 55.0 mol %.

For clarity, this proportion corresponds as the case may be to the proportion of the diamine of formula (II) or to the total proportion of the diamines of formula (II).

According to an embodiment, the diamine component (A) consists essentially of or consists of at least one bis(aminoalkyl)cyclohexane of formula (I) and at least one diamine of formula (II). All details provided above about the (aminoalkyl)cyclohexane of formula (I), the diamine of formula (II) and their respective proportions apply. The expression “consist essentially” means in the context of the invention in relation to the diamine component that the diamine component (A) comprises the indicated diamines and may also comprise up to 2.0 mol %, preferably up to 1.0 mol %, even more preferably up to 0.5 mol %, of at least one additional diamine other than the indicated ones, this proportion in mol % being based on the total amount of diamines in the diamine component (A).

### About the Diacid Component (B)

The dicarboxylic acid component (B) comprises terephthalic acid and optionally, one or more dicarboxylic acid(s) different from terephthalic acid.

According to an embodiment, the diacid component (B) consists essentially of or consists of terephthalic acid and the dicarboxylic acid of formula (III) with the following proportions:
a) between 70.0 and 100.0 mol. % of terephthalic acid;
b) between 0 and 30.0 mol. % of at least one dicarboxylic acid of formula (III);
   these proportions in mol % being based on the total amount of diacids in the diacid component (B).
      The expression “consist essentially” means in the context of the invention in relation to the diacid component that the diacid component (B) comprises the indicated diacids and may also comprise up to 2.0 mol %, preferably up to 1.0 mol %, even more preferably up to 0.5 mol %, of at least one additional carboxylic diacid other than the indicated ones, this proportion in mol % being based on the total amount of diacids in the diacid component (B).

Details are given about the proportions of the diacids in the diacid component (B). As it pertains to the diacid component, mol % of the referenced diacid is relative to the total number of moles of diacids in the diacid component (B).

The proportion of terephthalic acid in the dicarboxylic acid component (B) is at least 70.0 mol %. In some embodiments, the dicarboxylic acid component (B) consists of terephthalic acid, i.e., the proportion of terephthalic acid in the dicarboxylic acid component (B) is 100 mol %.

In some other embodiments, the proportion of terephthalic acid is between 80.0 and 95.0 mol %.

The diacid component (B) may further comprise one or more dicarboxylic acids other than terephthalic acid, according to formula (III):

HOOC—R₄—COOH (III)

where R₄ is a C₄-C₂₀ alkylene group or a C₄-C₂₀ arylene group. In some embodiments, R₄ is a C₄-C₁₆alkylene group or a C₄-C₁₆ arylene group. In some embodiments, R₄ is a C₄-C₁₂ alkylene group or a C₄-C₁₂ arylene group.

The proportion of the dicarboxylic acid(s) other than terephthalic acid is between 0 and 30.0 mol %. This proportion may be between 5.0 and 20.0 mol %. For clarity, this proportion corresponds as the case may be to the proportion of the dicarboxylic acid other than terephthalic acid or to the total proportion of the dicarboxylic acids other than terephthalic acid.

Suitable dicarboxylic acids of formula (III) can be aliphatic such as, for example, adipic acid (“AA” or “6”); undecanedioic acid; dodecanedioic acid; tridecanedioic acid; tetradecanedioic acid; pentadecanedioic acid; hexadecanedioic acid and octadecanedioic acid.

Suitable dicarboxylic acids can be cycloaliphatic dicarboxylic acids such as cyclohexanedicarboxylic acid, tetrahydrofuran-2,5-dicarboxylic acid, 1,3-adamantanedicarboxylic acid.

Suitable dicarboxylic acids of formula (III) are the aromatic dicarboxylic acids, other than terephthalic acid, which may be included in the dicarboxylic acid component (B). Suitable aromatic dicarboxylic acids include, but are not limited to, isophthalic acid (“IA” or “I”); naphthalenedicarboxylic acids (e.g. naphthalene-2,6-dicarboxylic acid); 4,4′-bibenzoic acid; 2,5-pyridinedicarboxylic acid; 2,4-pyridinedicarboxylic acid; 3,5-pyridinedicarboxylic acid; 2,2-bis(4-carboxyphenyl)propane; 2,2-bis(4-carboxyphenyl)hexafluoropropane; 2,2-bis(4-carboxyphenyl)ketone; 4,4′-bis(4-carboxyphenyl)sulfone; 2,2-bis(3-carboxyphenyl)propane; 2,2-bis(3-carboxyphenyl)hexafluoropropane; 2,2-bis(3-carboxyphenyl)ketone and bis(3-carboxyphenoxy) benzene.

The dicarboxylic acid of formula (III) may be more particularly selected in the group consisting of adipic acid; undecanedioic acid; dodecanedioic acid; tridecanedioic acid; tetradecanedioic acid; pentadecanedioic acid; hexadecanedioic acid; octadecanedioic acid, isophthalic acid and a combination of two or more of said diacids.

The dicarboxylic acid of formula (III) may more particularly be adipic acid, isophthalic acid or a combination of said two diacids.

According to a specific and preferred embodiment (E), the polyamide (PA) is formed polyamide (PA) formed from the polycondensation of a diamine component (A) and a diacid component (B), wherein:
the diamine component (A) comprises:
   a) between 40.0 and 80.0 mol % of a bis(aminoalkyl)cyclohexane selected in the group consisting of 1,3-bis(aminomethyl)cyclohexane, 1,4-bis(aminomethyl)cyclohexane and combination thereof; and
   b) between 20.0 and 60.0 mol % of a diamine of formula (II) selected in the group consisting of 1,9-nonamethylenediamine, 1,10-decamethylenediamine and a combination thereof;
the diacid component (B) comprises:
   a) between 70.0 and 100.0 mol. % of terephthalic acid;
   b) between 0 and 30.0 mol. % of at least one dicarboxylic acid other than terephthalic acid of formula (III) selected in the group consisting of adipic acid; undecanedioic acid; dodecanedioic acid; tridecanedioic acid; tetradecanedioic acid; pentadecanedioic acid; hexadecanedioic acid; octadecanedioic acid, isophthalic acid and a combination of two or more of said diacids.

More particularly, the polyamide (PA) is formed polyamide (PA) formed from the polycondensation of a diamine component (A) and a diacid component (B), wherein:
the diamine component (A) comprises:
   c) between 40.0 and 80.0 mol % of 1,3-bis(aminomethyl)cyclohexane; and
   d) between 20.0 and 60.0 mol % of a diamine of formula (II) selected in the group consisting of 1,9-nonamethylenediamine, 1,10-decamethylenediamine and a combination thereof;
the diacid component (B) comprises:
   c) between 70.0 and 100.0 mol. % of terephthalic acid;
   d) between 0 and 30.0 mol. % of at least one dicarboxylic acid other than terephthalic acid of formula (III) selected in the group consisting of adipic acid, isophthalic acid and a combination of two or more of said diacids.

The diamine of formula (II) may be:
1,9-nonamethylenediamine; or
1,10-decamethylenediamine; or
a combination of 1,9-nonamethylenediamine and 1,10-decamethylenediamine.

The diacid of formula (III) may be:
isophthalic acid;
adipic acid.

According to an embodiment, the polyamide (PA) comprises:
from 30.0 mol % to 75.0 mol % of recurring units R_{(PA1)} of formula (V):

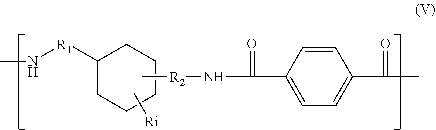

from 25.0 mol % to 70.0 mol % of (i) recurring units R_{(PA3)} of formula (VII) or (ii) a combination of recurring units R_{(PA2)}, R_{PA3)} and R_{(PA4)}, according to formulae (VI), (VII) and (VIII), respectively:

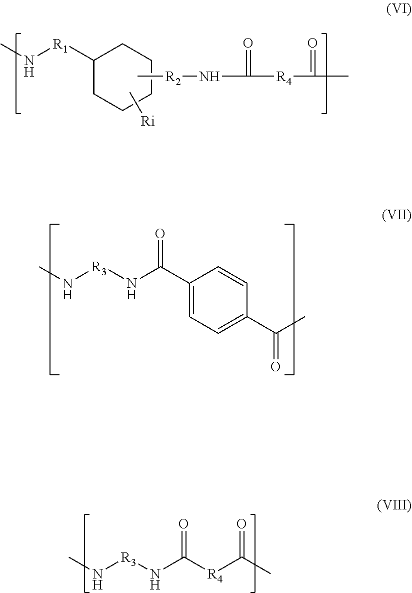

wherein
a. R₁ and R₂ are independently selected in the group of C₁-C₃ alkylenes groups;
b. the two aminoalkyl groups are relatively positioned in the meta position (1,3-) or the para position (1,4-) on the cyclohexane ring;
c. Rᵢ, at each location, is selected from the group consisting of an alkyl, an aryl, an alkali or alkaline earth metal sulfonate, an alkyl sulfonate, and a quaternary ammonium;
d. i is an integer from 0 to 10;
e. R₃ is a C₇-C₁₆ alkylene group, preferably a C₇-C₁₂ alkylene group;
f. R₄ is a C₆-C₂ alkylene group or a C₆-C₂₀ arylene, group, preferably a C₆-C₁₆ alkylene group or a C₆-C₁₆ arylene group, more preferably a C₆-C₁₂ alkylene group or a C₆-C₁₂ arylene group;
g. mol % is relative to the total moles of recurring units in the polyamide (PA).

In a preferred embodiment, i is 0 and R₁ and R₂ are both —CH₂—.

Preferably, the two aminoalkyl groups are relatively positioned in the meta position (1,3-).

The bis(aminoalkyl)cyclohexane can be a mixture of cis- and trans-bis(aminoalkyl)cyclohexane. The cis/trans ratio may be between 10/90 and 90/10, preferentially between 20/80 and 80/20 and even more preferentially between 30/70 and 70/30. In some embodiments, the cis/trans ratio is between 50/50 and 68/32.

Preferably, the recurring units of polyamide (PA) consist essentially in or consist in: (i) recurring R_{(PA1)} and recurring units R_{(PA3)} or (ii) recurring R_{(PA1)} and recurring units R_{(PA2)}, R_{(PA3)} and R_{(PA4)}.

### Recurring Units R_{(PA1)}

The person of ordinary skill in the art will recognize that the recurring units (R_{PA1}) according to formula (V) are formed from the polycondensation reaction of the bis(aminoalkyl)cyclohexane of formula (I) with terephthalic acid.

The proportion of recurring units (R_{PA1}) in the polyamide (PA) is from 30.0 mol % to 75.0 mol %. As used herein, mol % in reference to a recurring unit of the polyamide is relative to the total moles of recurring units in the polyamide (PA).

This proportion may be from 35.0 mol % to 70.0 mol %, preferably from 40.0 mol % to 65.0 mol %. This proportion may also be between 40.0 and 60.0 mol % or between 40.0 and 55.0 mol %.

Recurring Units R_{(PA2)}, R_{(PA3)}, and R_{(PA4)}

The polyamide (PA) comprises also (i) recurring units R_{(PA3)} or (ii) a combination of recurring units R_{(PA2)}, R_{(PA3)} and R_{(PA4)}. In both cases (i) and (ii), the proportion of recurring units R_{(PA3)} or of the combined recurring units R_{(PA2)}, R_{(PA3)} and R_{(PA4)} is from 25.0 mol % to 70.0 mol %.

This proportion may be from 30.0 mol % to 65.0 mol %, preferably from 35.0 mol % to 60.0 mol %. This proportion may also be between 40.0 and 60.0 mol % or between 45.0 and 60.0 mol %.

Preferably, i is 0 and R₁ and R₂ are both —CH₂—.

The two alkyl amino groups of the bis(aminoalkyl)cyclohexane in formula (V) and (VI) are relatively positioned in the meta position (1,3-) or the para position (1,4-). These two alkyl amino groups are preferably relatively positioned in the meta position (1,3-).

R₃ is a C₇-C₁₆ alkylene, preferably a C₇-C₁₂ alkylene, preferably a C₇-C₁₂ linear alkylene. R₃ is preferably selected in the group consisting of 1,9-nonamethylene, 1,10-decamethylene and combination of said two alkylene groups. R₃ may be 1,9-nonamethylene. R₃ may be 1,10-decamethylene.

R₄ is a C₄-C₂₀ alkylene group or a C₄-C₂₀ arylene group. In some embodiments, R₄ is a C₄-C₁₆ alkylene group or a C₄-C₁₆ arylene group. In some embodiments, R₄ is a C₄-C₁₂ alkylene group or a C₄-C₁₂ arylene group.

R₄ may more particularly be selected in the group consisting of the radicals derived from adipic acid (“AA” or “6”); undecanedioic acid; dodecanedioic acid; tridecanedioic acid; tetradecanedioic acid; pentadecanedioic acid; hexadecanedioic acid, octadecanedioic acid and combination of two or more of said radicals.

R₄ may more particularly be selected in the group consisting of the radicals derived from adipic acid, isophthalic acid or a combination of said two diacids.

### Thermal Properties of the Polyamide (PA)

The polyamide (PA) exhibits a combination of thermal properties than makes it suitable for being used in additive manufacturing.

The polyamide (PA) is semi-crystalline.

The polyamide (PA) preferably exhibits a glass transition temperature (Tg) of at least 120° C. The Tg is preferably at least 125° C., preferably at least 130° C., preferably at least 140° C., preferably at least 150° C.

The polyamide (PA) generally exhibits a Tg of no more than 200° C. The Tg may be no more than 190° C., no more than 180° C., or no more than 170° C.

Tg may be from 120° C. to 200° C., from 125° C. to 190° C., or from 130° C. to 180° C. Tg may also be from 130° C. to 190° C., from 130° C. to 180° C., or from 130° C. to 170° C.

The polyamide (PA) preferably exhibits a melting temperature (Tm) of at most 290° C. Tm is preferably at least 240° C.

In some embodiments, the polyamide (PA) has a Tm of at least 235° C., at least 240° C., at least 245° C., at least 250° C. In some embodiments, the polyamide (PA) has a Tm of no more than 290° C., no more than 285° C., no more than 280° C. or no more than 275° C.

In some embodiments, the polyamide (PA) has a Tm of from 235° C. to 290° C., from 240° C. to 285° C., from 245° C. to 280° C. or from 250° C. to 275° C.

The polyamide (PA) preferably exhibits a heat of fusion (“Hm”) of at least 20.0 J/g. Hm is generally no more than no more than 75.0 J/g, more particularly no more than 70.0 J/g or no more than 65.0 J/g.

Hm may be from 20.0 J/g to 75.0 J/g, from 25.0 J/g to 70.0 J/g, or from 30.0 J/g to 65.0 J/g. Hm may also be from 20.0 J/g to 70.0 J/g, or from 20.0 J/g to 65.0 J/g.

Tg, Tm and Hm are measured by Differential Scanning Calorimetry according to ASTM D3418 using a heating and a cooling rate of 20° C./min.

Tg, Tm and Hm can more particularly be measured by Differential Scanning Calorimetry with the procedure given in the experimental section.

In addition to the thermal resistance, the polyamide (PA) exhibits also a combination of other properties such as stiffness, strength and chemical resistance, that renders the polyamide suitable for additive manufacturing.

The polyamide (PA) has generally a number average molecular weight (“Mn”) from 1,000 g/mol to 40,000 g/mol, from 2,000 g/mol to 35,000 g/mol, from 4,000 to 30,000 g/mol, or from 5,000 g/mol to 20,000 g/mol. Mn can be determined by gel permeation chromatography (GPC) using ASTM D52%.

### Preparation of the Polyamide (PA)

The polyamide (PA) is formed by polycondensation from a reaction mixture including the diamine component (A) and the dicarboxylic acid component (B) as disclosed herein.

The skilled person understands then that the proportion of —NH₂ from the diamine component (A) and the proportion of —COOH from the dicarboxylic acid component (B) are substantially equimolar. As used herein in relation to the reaction mixture, “substantially equimolar” means that the total number of moles of diamines in the reaction mixture is ±15% of the total number of moles of dicarboxylic acids in the reaction mixture. The ratio —NH₂/COOH is preferably between 0.9 to 1.1, preferentially 0.95 to 1.05, even more preferentially between 0.98 to 1.02.

The polyamide (PA) is generally prepared by reacting the monomers (e.g. the diamines and dicarboxylic acids) of the reaction mixture in the presence of less than 60 wt. %, less than 30 wt. %, less than 20 wt. %, less than 10 wt. %, or no added water. The monomers are caused to react by heating the reaction mixture to a temperature of at least Tm+10° C., Tm being the melting temperature of the polyamide (PA).

The temperature at which the reaction mixture is heated must be high enough to induce the reaction between the amine groups and the carboxylic groups and to decrease the viscosity of the mixture. This temperature is generally at least 250° C. The polycondensation results in the formation of the amide bonds and the release of water as a by-product.

The temperature can be step-wise increased in the course of the polycondensation.

The reaction mixture preferably comprises a catalyst. The catalyst may be selected in the group consisting of phosphorous acid, ortho-phosphoric acid, meta-phosphoric acid, alkali-metal hypophosphite such as sodium hypophosphite and phenylphosphinic acid. A convenient catalyst used is phosphorous acid.

For the control of the molar mass, the reaction mixture may also further comprise at least one chain limiter, preferably selected from C₁-C₁₈ monocarboxylic acids and C₃-C₁₈ monoamines. The chain transfer agent may more particularly be selected in the group consisting of acetic acid, propanoic acid, butyric acid, valeric acid, caproic acid, lauric acid, stearic acid, 2-ethylhexanoic acid, cyclohexanoic acid, benzoic acid, butylamine, pentylamine, hexylamine, 2-ethylhexylamine, n-octylamine, n-dodecylamine, n-tetradecylamine, n-hexadecylamine, stearylamine, cyclohexylamine and mixtures thereof. The polyamide (PA) may thus contain a chain limiter.

The preparations disclosed in the experimental section may be followed for the preparation of the polyamide (PA).

### The Polymer Composition (PC)

The filament of the invention is made of or comprises a polymer composition (PC). The polymer composition (PC) comprises at least 50.0 wt % of at least one polyamide (PA) as defined herein. The proportions of the components of the polymer composition (PC) are expressed relative to the total weight of the polymer composition (PC).

According to an embodiment, the polymer composition (PC) comprises the polyamide (PA) only. The proportion of the polyamide (PA) in the polymer composition is 100 wt. %. In such embodiment, the polymer composition (PC) consists of the polyamide (PA).

According to another embodiment, the proportion of polyamide (PA) is at least 55 wt. %, at least 60 wt. % or at least 65 wt. %. This proportion is generally no more than 99.9 wt. %, no more than 99.5 wt. %, no more than 95 wt. %, or no more than 90.0 wt. %. In some embodiments, this proportion is from 50.0 wt. % to 99.9 wt. %, from 55.0 wt. % to 99.5 wt. %, from 60.0 wt. % to 95.0 wt. %, or from 65.0 wt. % to 90.0 wt. %.

### Reinforcing Agents

The polymer composition (PC) may comprise at least one reinforcing agent.

The proportion of reinforcing agent(s) in the polymer composition (PC) is at least 5.0 wt. %, at least 10.0 wt. % or at least 15.0 wt. %. This proportion is generally no more than 50.0 wt. %, no more than 45.0 wt. %, or no more than 40.0 wt. %.

This proportion may be from 5.0 wt. % to 50.0 wt. %, from 10.0 wt. % to 45.0 wt. % or from 15.0 wt. % to 40.0 wt. %.

The reinforcing agent may be selected in the group consisting of mineral fillers (such as talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers, wollastonite and any combination of two or more thereof.

The reinforcing agent may more particularly be selected in the group consisting of carbon fibers, glass fibers and a combination of said two reinforcing agents.

The reinforcing agent may more particularly be selected in the group consisting of fibrous and particulate reinforcing agents. A fibrous reinforcing agent is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. Suitable fibrous reinforcing agents (e.g. glass fibers or carbon fibers) can have an average length of from 3 mm to 50 mm. In embodiments including fibrous reinforcing agents, the fibers have an average length of from 3 mm to 10 mm, from 3 mm to 8 mm, from 3 mm to 6 mm, or from 3 mm to 5 mm. In alternative embodiments, the fibers have an average length of from 10 mm to 50 mm, from 10 mm to 45 mm, from 10 mm to 35 mm, from 10 mm to 30 mm, from 10 mm to 25 mm, or from 10 mm to 20 mm. The average length of the fibers can be taken as the average length of the fibers prior to incorporation into the polymer composition or can be taken as the average length of the fibers within the polymer composition.

The reinforcing agent is advantageously a fibrous filler and preferably a fibrous filler that is able to withstand the high temperature applications. Glass fibers are particularly preferred. All glass fiber types, such as A, C, D, E, M, S, R, T glass fibers (as described in chapter 5.2.3, pages 43-48 of Additives for Plastics Handbook, 2nd ed., John Murphy), or any mixtures thereof or mixtures thereof may be used. Additional descriptions of E, R, S and T glass fibers can be found in, e.g., Fiberglass and Glass Technology, Wallenberger, Frederick T.; Bingham, Paul A. (Eds.), 2010, XIV, chapter 5, pages 197-225.

The glass fiber preferably exhibits a high modulus. High modulus glass fibers have generally an elastic modulus of at least 76, preferably at least 78, more preferably at least 80, and most preferably at least 82 GPa as measured according to ASTM D2343. Examples of high modulus glass fibers include, but are not limited to, R, S and T glass fibers. R, S and T glass fibers are composed essentially of oxides of silicon, aluminum and magnesium, and typically from 62-75 wt. % of SiO₂, from 16-28 wt. % of Al₂O₃ and from 5-14 wt. % of MgO. R, S and T glass fibers comprise less than 10 wt. % of CaO. High modulus glass fibers include S-1 and S-2 glass fibers, commercially available from Taishan and AGY, respectively.

The morphology of the glass fiber is not particularly limited. As noted above, the glass fiber can be round, i.e., have a circular cross-section, or flat, i.e., have a non-circular cross-section, such as an oval, elliptical or rectangular cross section.

### Additives

In addition to the polyamide (PA) and optional reinforcing agents, the polymer composition (PC) may further optionally comprise one or more additives selected from the group consisting of tougheners, plasticizers, colorants, pigments (e.g. black pigments such as carbon black and nigrosine), antistatic agents, dyes, lubricants (e.g. linear low density polyethylene, calcium or magnesium stearate or sodium montanate), thermal stabilizers, light stabilizers, flame retardants (e.g. halogen free flame retardants), nucleating agents, antioxidants and any combination thereof.

The halogen free flame retardant may more particularly be selected in the group consisting of metal dialkyl phosphinates (e.g. aluminum diethyl phosphinate), organophosphates (e.g. triphenylphosphates) and phosphonates (e.g. dimethyl methylphosphonates).

The polymer composition (PC) may also include a toughener. A toughener is generally a low Tg polymer, with a Tg for example below room temperature, below WC or even below −25° C. As a result of its low Tg, the toughener is typically elastomeric at room temperature. Tougheners can be functionalized polymers and are therefore typically reactive with other components of the polymer composition. The toughener may more particularly be selected in the group consisting of polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

A toughener can be functionalized by copolymerization of monomers containing reactive functionalities or from the grafting of reactive groups onto the toughener. Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene copolymers grafted with maleic anhydride; SEBS copolymers grafted with maleic anhydride; styrene-acrylonitrile copolymers grafted with maleic anhydride; ABS copolymers grafted with maleic anhydride.

The proportion of toughener(s) in the polymer composition (PC) is generally at least 0.1 wt. %, at least 0.2 wt. %, at least 0.3 wt. %, at least 0.4 wt. %, or at least 0.5 wt. %. This proportion is generally no more than 30.0 wt. %, no more than 25.0 wt. %, no more than 20.0 wt. %, no more than 15.0 wt. % or no more than 10.0 wt. %. This proportion may be from 0.1 wt. % to 30.0 wt. %, from 0.2 wt. % to 25.0 wt. %, from 0.3 wt. % to 20.0 wt. %, from 0.4 wt. % to 15.0 wt. % or from 0.5 wt. % to 10.0 wt. %.

### Other Polymer(s)

The polymer composition (PC) may also comprise one or more polymeric materials.

The additional polymeric material(s) may for example be selected from the group consisting of polyamides; poly(arylene sulphide) (PAS) polymers (for example homopolymer of poly(phenylene sulphide) (PPS) polymer); poly(aryl ether sulfone) (PAES) polymers (for example a poly(biphenyl ether sulfone) (PPSU) polymer or a polysulfone (PSU) polymer) and poly(aryl ether ketone) (PAEK) polymers (for example a poly(ether ether ketone) (PEEK) polymer).

According to a preferred embodiment, the polymer composition (PC) comprises at least one polyamide other than polyamide (PA). This other polyamide may be amorphous or semi-crystalline. The other polyamide may be an aliphatic polyamide or a semi-aromatic polyamide. The other polyamide may be selected in the group of PA6, PA66, PA11, a PA12 and combination of two or more of said polyamides.

Preferably, the polymer composition (PC) comprises only the at least polyamide (PA) as s polymer component.

The polymer compositions (PC) can be made with methods well known in the art. For example, the polymer composition (PC) can be made by melt-blending the polyamide (PA) and the other ingredients.

Any melt-blending method may be used. For example, polymeric ingredients and non-polymeric ingredients may be fed into a melt mixer, such as single screw extruder or twin screw extruder, agitator, single screw or twin screw kneader, or Banbury mixer. The ingredients may be fed all at once or via gradual addition, in batches. If a reinforcing agent presents a long physical shape (for example, a long glass fiber), drawing extrusion molding may be used to prepare a reinforced composition.

The polymer composition (PC) may conveniently be prepared with an extruder.

According to a preferred embodiment, the polymer composition (PC) comprises or consists of:
at least 50.0 wt % of at least one polyamide (PA) as defined herein;
optionally at least one reinforcing agent as defined herein;
optionally one or more additives selected from the group consisting of tougheners, plasticizers, colorants, pigments, antistatic agents, dyes, lubricants, thermal stabilizers, light stabilizers, flame retardants, nucleating agents, antioxidants and any combination thereof.

### Articles and Applications Thereof

The present invention also relates to an article or composite material formed by the additive manufacturing of the filament. The article is suitable for use in or as mobile electronics components, LED packaging, oil and gas components, food contact components, electrical and electronic device components, medical device components, construction components, industrial components, plumbing components, automotive parts, and aerospace parts.

In some embodiments, the article is a mobile electronic device component. As used herein, a “mobile electronic device” refers to an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch, smart glasses and the like), a camera, a portable audio player, a portable radio, global position system receivers, and portable game consoles.

In some embodiments, the mobile electronic device component is a radio antenna. In such embodiments, the radio antenna can be a WiFi antenna or an RFID antenna. The mobile electronic device component may also be an antenna housing.

In some embodiments, the mobile electronic device component is an antenna housing. In some such embodiments, at least a portion of the radio antenna is in contact with the polyamide or polymer composition. Additionally or alternatively, at least a portion of the radio antenna can be displaced from the polyamide or polymer composition. In some embodiments, the device component can be of a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switch pad. In some embodiments, the mobile electronic device can be at least a portion of an input device. Examples of electric and electronics devices are connectors, contactors and switches.

In some embodiments, the article is an automotive component. Examples of automotive components include, but are not limited to, components in thermal management systems (including, but not limited to, thermostat housings, water inlet/outlet valves, water pumps, water pump impellers, and heater cores and end caps), air management system components (including, but not limited to, turbocharger actuators, turbocharger by-pass valves, turbocharger hoses, exhaust gas recirculation (“EGR”) valves, charged air cooler (“CAC”) housings, exhaust gas recirculation systems, electronic controlled throttle valves, and hot air ducts), transmission components and launch device components (including, but not limited to, dual clutch transmissions, automated manual transmissions, continuously variable transmissions, automatic transmissions, torque convertors, dual mass flywheels, power takeoffs, clutch cylinders, seal rings, thrust washers, thrust bearings, needle bearings, and check balls), automotive electronic components, automotive lighting components (including, but not limited to, motor end caps, sensors, electronic control unit (“ECU”) housings, bobbins and solenoids, connectors, circuit protection/relays, actuator housings, lithium ion battery systems, and fuse boxes), traction motor and power electronic components (including, but not limited to, battery packs), fuel and selective catalytic reduction (“SCR”) systems (including, but not limited to, SCR module housings and connectors, SCR module housings and connectors, fuel flanges, rollover valves, quick connects, filter housings, fuel rails, fuel delivery modules, fuel hoses, fuel pumps, fuel injector o-rings, and fuel hoses), braking system elements, and other fluid system, interior and structural components (e.g., inlet and outlet valves, fluid pump components, dashboard components, display components, and seating components, gears and bearings, sunroofs, and brackets and mounts).

In an embodiment, the filament is used in the additive manufacturing process to provide a composite material. In some embodiments, the composite material is a continuous fiber reinforced thermoplastic. The fibers may be continuous carbon or glass fibers, or may be aramid fibers.

Exemplary embodiments will now be described in the following non-limiting examples.

### Experimental Section

### Raw Materials Used

1,6-hexamethylenediamine (HMDA) (70 wt. %, Ascend Performance Materials).
1,9-nonamethylenediamine (NDA, Sigma-Aldrich).
1,10-decamethylenediamine (DMDA, Hangzhou Dayangchem Co).
2,2,4(2,4,4)-trimethylhexamethylenediamine (TMD, Sigma-Aldrich).
1,3-bis(aminomethyl)cyclohexane (1,3-BAC, Mitsubishi Gas Chemical Company).
Terephthalic acid (Flint Hills Resources).
Isophthalic acid (Flint Hills Resources).
Adipic acid (Invista).
Phosphorus acid (Sigma Aldrich).
Glacial acetic acid (Sigma-Aldrich).

### Preparation of the Polyamides

Small sample sizes (e.g., 1-10 kg) of the copolyamides were prepared in a stirred autoclave reactor equipped with a distillate line and a pressure control valve. For example, polyamide E1 was prepared by charging into the reactor a diamine component consisting of 116 grams of 1,3-bis(aminomethyl)cyclohexane and 127 grams of 1,9-nonamethylenediamine, a dicarboxylic acid component consisting of 262 grams of terephthalic acid, 287 grams of deionized water, 2.9 grams of glacial acetic acid and 0.14 gram of phosphorus acid. The reactor was sealed, purged with nitrogen 3 times and heated to 260° C. The steam generated was slowly released to keep the internal pressure at 265 psig. The temperature was then increased to 310° C. in 30 minutes. The reactor pressure was slowly reduced to atmospheric within 30 minutes. After holding for an additional 20 minutes with nitrogen purging, the polymer was discharged from the bottom reactor and the cooled strands were pelletized.

The following process was used to prepare 10-100 kg quantities of copolyamide (preparation of polyamide E1 is described here as an example): a stirred batch vessel was charged with 21.52 kg deionized water, a diamine component consisting of 8.71 kg 1,3-bis(aminomethyl)cyclohexane and 9.50 kg of 1,9-nonamethylenediamine, a dicarboxylic acid component consisting of 19.64 kg of terephthalic acid, 10.66 grams phosphorus acid and 216.18 grams of glacial acetic acid. The reactor was heated to 150° C. and the contents pumped to a reactor zone maintained at about 185 psig and 220° C., then to a high pressure zone maintained at 300° C. and then through a tubular reactor maintained at 100 psig and 350° C. The melt was fed into a twin-screw extruder equipped with a forward vacuum vent. The finished polymer was extruded through a strand die into a water bath which was then chopped into pellets.

Tg, Tm and Hm of the polyamides were measured by Differential Scanning Calorimetry (“DSC”) according to ASTM D3418 using a heating and cooling rate of 20° C./min. Three scans were used for each DSC test: a first heat to 350° C., followed by a first cool to 30° C., followed by a second heat to 360° C. The Tg and the Tm were determined from the second heat.

In Tables 1 and 3, “Diamine mol %” indicates mol % of the diamine indicated, relative to the total moles of diamines in the diamine component of the reaction mixture used to form the polyamide; and “Diacid, mol %” indicates mol % of the diacid indicated, relative to the total moles of dicarboxylic acids in the dicarboxylic acid component of the reaction mixture used to form the polyamide. In Table 2, “mol % R_{(PAX)}” indicates mol % of the recurring unit indicated, relative to the total moles of recurring units in the polyamide.

TABLE 1

| | Diamine, mol % | | | | | Diacid, mol % | | | Properties | | |
|---|---|---|---|---|---|---|---|---|---|---|---|
| Sample ID | HMDA | NDA | DMDA | TMD | 1,3-BAC | TA | IA | AA | Tg, C | Tm, C | Hm (J/g) |
| C1 | 100 | | | | | 100 | | | | >380 (dec) | |
| C2 | | 100 | | | | 100 | | | 115 | 318 | 85 |
| C3 | | | 100 | | | 100 | | | 119 | 319 | 83 |
| C4 | | | | 100 | | 100 | | | 149 | — | — |
| C5 | | | | | 100 | 100 | | | 182 | 337 | 75 |
| C6 | | 20 | | | 80 | 100 | | | 170 | 298 | 45 |
| E1 | | 40 | | | 60 | 100 | | | 155 | 276 | 44 |
| E2 | | | 45 | | 55 | 100 | | | 150 | 283 | 62 |
| E3 | | 50 | | | 50 | 100 | | | 152 | 256 | 36 |
| E4 | | | 55 | | 45 | 100 | | | 150 | 276 | 53 |

As shown in Table 1, comparative sample C1 was semi-crystalline resin but had a Tm too high to be melt processed. Comparative samples C2 and C3 had Tg's of less than 120° C. and Tm's of greater than 290° C. As a result, samples C2 and C3 are not amenable to additive manufacturing methods. As further shown in Table 1, while comparative samples C4-C6 had Tg's greater than 120° C., C4 was amorphous, and C5 and C6 had Tm's greater than 290° C. Thus, sample C4 is not likely to be useful in applications requiring strength and stiffness above 120° C., and samples C5 and C6 are not amenable to additive manufacturing methods.

On the other hand, those samples having from 30 mol % to 75 mol % bis(aminomethyl)cyclohexane (inventive samples E1-E4) have a Tg of 120° C. or greater, a melting enthalpy of greater than 20 J/g and Tm's of <290° C., so that these samples are suitable for additive manufacturing. Thus, articles formed from samples E1-E4 are also heat resistant and would be expected retain their mechanical properties at temperatures of up to the Tg of these samples.

In other words, the inventive samples have a high Tg, while maintaining a low Tm such that the polyamide is processable using additive manufacturing techniques.

Additional samples were prepared in accordance with the methodology described above, having the compositions outlined in the Tables below.

TABLE 2

| PA | R_{(PA#)} | C7 | C8 | E5 | E6 | E7 | E8 | E9 | E10 |
|---|---|---|---|---|---|---|---|---|---|
| BAC.T | R_{(PA1)} | 45 | 45 | 54 | 54 | 45 | 45 | 45 | 42.5 |
| BAC.I | R_{(PA2)} | 5 | 5 | 3 | | 5 | 2.5 | 5 | 7.5 |
| BAC.6 | R_{(PA2)} | | | 3 | 6 | | 2.5 | | |
| 6.T | | 45 | 45 | | | | | | |
| 6.I | | 5 | | | | | | | |
| 6.6 | | | 5 | | | | | | |
| 9.T | R_{(PA3)} | | | 36 | 36 | | | | |
| 9.I | R_{(PA4)} | | | 2 | | | | | |
| 9.6 | R_{(PA4)} | | | 2 | 4 | | | | |
| 10.T | R_{(PA3)} | | | | | 45 | 45 | 45 | 42.5 |
| 10.I | R_{(PA4)} | | | | | 5 | 2.5 | | 7.5 |
| 10.6 | R_{(PA4)} | | | | | | 2.5 | 5 | |

TABLE 3

| | Diamine, mol % | | | | Diacid, mol % | | | Properties | | |
|---|---|---|---|---|---|---|---|---|---|---|
| Sample ID | HMDA | NDA | DMDA | 1,3-BAC | TA | IA | AA | Tg, C | Tm, C | Hm (J/g) |
| C7 | 50 | | | 50 | 90 | 10 | | 168 | — | — |
| C8 | 50 | | | 50 | 90 | | 10 | 176 | — | — |
| E5 | | 40 | | 60 | 90 | 5 | 5 | 163 | 259 | 23 |
| E6 | | 40 | | 60 | 90 | | 10 | 154 | 256 | 31 |
| E7 | | | 50 | 50 | 90 | 10 | | 153 | 259 | 37 |
| E8 | | | 50 | 50 | 90 | 5 | 5 | 141 | 258 | 45 |
| E9 | | | 50 | 50 | 90 | | 10 | 134 | 262 | 49 |
| E10 | | | 50 | 50 | 85 | 15 | | 151 | 249 | 25 |

As shown in Table 3, comparative samples C7 and C8 were amorphous and had no measurable heat of fusion or melting temperature. These materials would not have the strength and rigidity desired in the intended applications. On the other hand, samples E5-E10 all have Tg's greater than 120° C., Tm's between 250° C. and 265° C. and a heat of fusion between 20 J/g and 50 J/g. As a result, articles manufactured from these samples are expected to have good heat resistance, i.e., to retain their mechanical properties at temperatures up to the Tg of the material. Filaments comprising these materials are also readily processable by additive manufacturing methods.

### Preparation of the Filaments

Feed stocks for filament production consisted of either neat polyamide pellets or compounds made from the polyamide and chopped carbon fiber (20 wt. %). Filament of diameter 1.75 mm was prepared for each composition using a Brabender® Intelli-Torque Plasti-Corder® Torque Rheometer extruder (see https://www.cwbrabender.com/en/chemical/products/drive-units/intelli-torque-plasti-corder-torque-rheometer/) equipped with a 0.75″ (1.905 cm) 32 ID general purpose single screw, a heated capillary die attachment, a 3/32″ diameter nozzle with land length of 1.5″, and a downstream filament conveying apparatus. Other downstream equipment included a belt puller and a Dual Station Coiler, both manufactured by ESI-Extrusion Services. A Beta LaserMike® 5012 with DataPro 1000 data controller was used to monitor filament dimensions.

The melt strand was cooled with air. The Brabender® zone set point temperatures were 240-285° C. in the barrel zone and 295° C. at the die. The Brabender® speed ranged from 25 to 60 rpm and the puller speed from 20 to 70 feet per minute (6.093 to 21.336 meters per minute).

The filaments produced had a diameter d of 1.75 mm±0.1 mm.

In all cases, the filaments could be prepared with a good quality.

### 3D Printing

The filaments described above were printed with the neat polyamides on an Argo 500 extrusion-based additive manufacturing system commercially available from Roboze Inc. (Houston, Texas, USA, or Bara, Italy). Polyphenylsulphone build sheets were employed as the printed object substrate. During the printing trials, nozzle temperature was set between 340° C. and 380° C., and the heated chamber was set between 140° C. and 170° C. A 0.6 mm Roboze Argo Tip3-HSA tip was used, with a 0.1 mm to 0.3 mm thickness deposited in each layer. The material was extruded in a layer-by-layer fashion to print structures in the heated chamber. ASTM Type I, IV or V tensile bars were printed of PA12 (Tg<120° C., control) and of inventive samples E6 and E10, using 100% infill and either 45°/−45° alternating rasters or 0°/90° alternating rasters. Objects were promptly removed from the heated chamber and build sheet after printing. The inventive polyamide filament had good printability, with good adhesion between layers.

Tg and Tm of inventive sample E6 were measured according to ASTM D3418, and the modulus was measured according to ASTM D638. Publicly available data for PA12 was used. See, e.g., https://support.stratasys.com/en/materials/fdm/fdm-nylon-12.

TABLE 4

| Material | Tg, ° C. | Tm, ° C. | Modulus, GPa |
|---|---|---|---|
| PA12 | 34 | 174 | 1.5 |
| E6 (invention) | 154 | 256 | 2.2 |
| E10 (invention) | 151 | 249 | 2.2 |

1. An additive manufacturing filament comprising a polymer composition (PC) which comprises at least 50.0 wt. % of at least one polyamide (PA) formed from polycondensation of a diamine component (A) and a diacid component (B), wherein:
the diamine component (A) consists essentially of:
a) between 40.0 and 80.0 mol % of at least one bis(aminoalkyl)cyclohexane represented by formula (I): 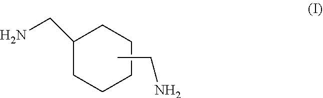
where the CH₂— amino groups are relatively positioned in the meta position (1,3-) or the para position (1,4-); and
b) between 20.0 and 60.0 mol % of at least one diamine of formula (II):
H₂N—R₃—NH₂ (II)
where R₃ is a C₇-C₁₆ aliphatic alkylene group;
wherein proportions in mol % are based on a total amount of diamines in the diamine component (A);
the diacid component (B) consists essentially of:
c) between 70.0 and 100.0 mol. % of terephthalic acid;
d) between 0 and 30.0 mol. % of at least one dicarboxylic acid other than terephthalic acid of formula (III):
HOOC—R₄—COOH (III)
where R₄ is a C₄-C₂₀ alkylene group or a C₇-C₂₀ arylene group;
wherein proportions in mol % are based on a total amount of diacids in the diacid component (B).

2. (canceled)

3. (canceled)

4. (canceled)

5. (canceled)

6. (canceled)

7. (canceled)

8. (canceled)

9. The filament of claim 1, wherein the bis(aminoalkyl)cyclohexane is 1,3-bis(aminomethyl)cyclohexane.

10. The filament of claim 1, wherein the diamine of formula (II) is selected from the group consisting of 1,9-diaminononane, 1,10-diaminodecane and a combination of said two amines.

11. The filament of claim 1, wherein the proportion of terephthalic acid in the diacid component (B) is 100.0 mol %.

12. The filament of claim 1, wherein the proportion of terephthalic acid in the diacid component (B) is between 80.0 and 95.0 mol %.

13. The filament of claim 1, wherein the proportion of the dicarboxylic acid(s) other than terephthalic acid in the diacid component (B) is between 5.0 and 20.0 mol %.

14. (canceled)

15. The filament of claim 1, wherein the dicarboxylic acid of formula (III) is selected from the group consisting of adipic acid, isophthalic acid and a combination of two or more of said diacids.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. The filament according to claim 1, wherein the polyamide (PA) exhibits a glass transition temperature (Tg) of at least 120° C.

28. The filament according to claim 1, wherein the polyamide (PA) exhibits a melting temperature (Tm) of at most 290° C.

29. The filament according to claim 1, wherein the polyamide (PA) exhibits a melting temperature (Tm) of at least 240° C.

30. The filament according to claim 1, wherein the polyamide (PA) exhibits a heat of fusion (“Hm”) of at least 20.0 J/g.

31. The filament according to claim 1, wherein the polymer composition (PC) comprises at least one reinforcing agent, selected from the group consisting of mineral fillers, glass fibers, carbon fibers, synthetic polymeric fibers, aramid fibers, aluminum fibers, titanium fibers, magnesium fibers, boron carbide fibers, rock wool fibers, steel fibers, wollastonite and any combination of two or more thereof.

32. (canceled)

33. The filament according to claim 1, wherein the polymer composition (PC) comprises one or more additives selected from the group consisting of tougheners, plasticizers, colorants, pigments, antistatic agents, dyes, lubricants, thermal stabilizers, light stabilizers, flame retardants, nucleating agents, antioxidants and any combination thereof.

34. (canceled)

35. The filament according to claim 1, having a diameter d between 0.5 mm and 5.0 mm.

36. (canceled)

37. (canceled)

38. The filament according to claim 1, having a substantially circular cross-section or a circular cross-section.

39. The filament according to claim 1, having a length L of at least 200 mm.

40. A spool comprising the filament according to claim 39.

41. (canceled)

42. A method of making a three-dimensional (3D) object comprising the step of printing layers of the three-dimensional object with the polymer composition (PC) of the filament according to claim 39.

43. (canceled)

44. (canceled)
